(19) United States
(12) Patent Application Publication
(10) Pub. No.: US 2026/0365095 A1
(43) Pub. Date: Nov. 19, 2026

(54) HEADREST FOR A MOTOR VEHICLE SEAT

(71) Applicant: TREVES PRODUCTS,SERVICES & INNOVATION, Issy-Les-Moulineaux (FR)

(72) Inventors: Xavier BONFILS, Issy-Les-Moulineaux (FR); Eric BRILLON, Issy-Les-Moulineaux (FR); Arnaud DUVAL, Issy-Les-Moulineaux (FR)

(21) Appl. No.: 19/133,743

(22) PCT Filed: Nov. 30, 2023
(86) PCT No.: PCT/EP2023/083846

§ 371 Date: May 29, 2025

(30) Foreign Application Priority Data
Dec. 1, 2022 (FR) FR2212641

(51) Int. Cl. B60N 2/879; H04R 1/02

(52) U.S. Cl. CPC B60N 2/879; H04R 1/025; H04R 2499/13

(57) ABSTRACT

The invention relates to a headrest comprising a bearing block (1) provided with a padding cushion (2) made of elastically compressible foam, supported by a rigid frame (3) for mounting the headrest at the top of the backrest of the seat, the headrest being equipped with an acoustic wave generator which comprises at least one plate (6) on which an electrodynamic transducer (7) is provided, said plate being attached to the bearing block (1) and being arranged to be excited vibrationally by said transducer in order to generate the acoustic waves, the headrest comprising a vibrational decoupling means (9, 10) which is arranged between said plate and said bearing block and/or between said bearing block and the rigid frame (3), said decoupling means comprising an elastomer material having a Young's modulus E of less than 20 kPa.

The invention relates to a headrest for a motor vehicle seat, as well as to an assembly for generating acoustic waves in a motor vehicle passenger compartment comprising such a headrest.

It is known to equip a headrest with an acoustic wave generator enabling a sound signal to be emitted close to the head of an occupant of the seat on which said headrest is mounted. The waves are then generated as close as possible to the user's ears in order to limit acoustic losses.

In addition to an audible signal, the generator can emit an “anti-noise” type sound signal, i.e. in phase opposition to the noise inside the passenger compartment, so as to enable active control of noise within said passenger compartment.

To do so, at least one loudspeaker can be integrated into the volume of the headrest. However, the size of a loudspeaker makes it difficult to fit into a piece of reduced size such as a headrest, and its weight makes the headrest fitted with it noticeably heavier.

In addition, the loudspeakers fitted to the headrests emit at medium and/or high frequencies but, for reasons of size, cannot emit at frequencies below 150 Hz, whereas these low frequencies, in particular frequencies of 100 Hz or even 60 Hz, are necessary for the quality of a sound signal, in particular of the “anti-noise” type.

Acoustic wave generators are known, comprising a rigid plate which is excited vibrationnally by an electrodynamic transducer in order to generate said waves. In this way, the transducer allows to transform an electrical control signal into an acoustic signal, by using the plate on which it is attached as a radiation surface.

The compactness of this solution makes it possible to limit the space required for the acoustic wave generator to be integrated into a headrest, but generates a significant problem of vibration transmission to said headrest, which can be a source of discomfort in the environment around said headrest, particularly for the passenger seated on the seat equipped with it.

The aim of the invention is to provide a headrest that allows to overcome these disadvantages, particularly in terms of vibration transmission between the headrest and the seat on which it is mounted.

To this end, according to a first aspect, the invention proposes a headrest for a motor vehicle seat, said headrest comprising a bearing block provided with a padding cushion made of elastically compressible foam, said block being supported by a rigid frame for mounting said headrest at the top of the backrest of said seat, said headrest being equipped with a generator for generating acoustic waves in the environment of said headrest, the generator comprising at least one plate on which an electrodynamic transducer is provided, said plate being attached to the bearing block and arranged to be excited vibrationally by said transducer in order to generate the acoustic waves, said headrest comprising a vibrational decoupling means which is arranged between said plate and said bearing block and/or between said bearing block and the rigid frame, said decoupling means comprising an elastomer material having a Young's modulus E of less than 20 kPa.

According to a second aspect, the invention proposes an assembly for generating acoustic waves in a motor vehicle passenger compartment, said assembly comprising such a headrest and a system for controlling at least one transducer to excite vibrationally the plate on which it is provided.

Further features and advantages of the invention will become apparent from the following description, made with reference to the appended figures, in which:

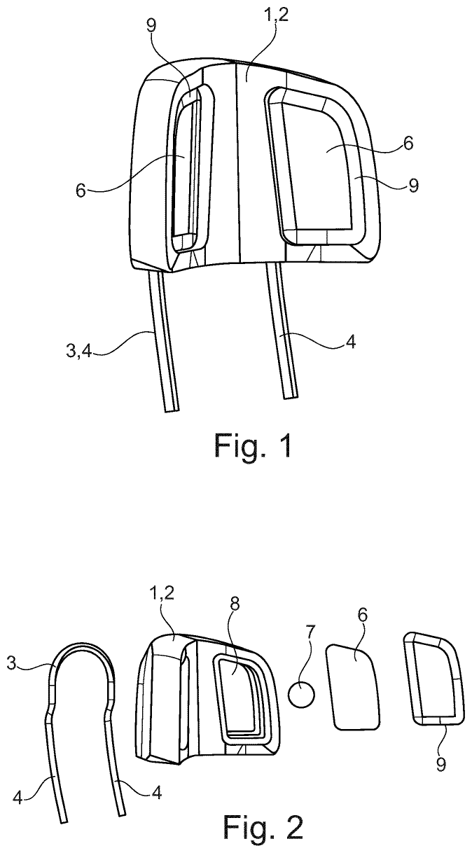

FIG. 1 is a schematic perspective front view of a headrest according to one embodiment of the invention;

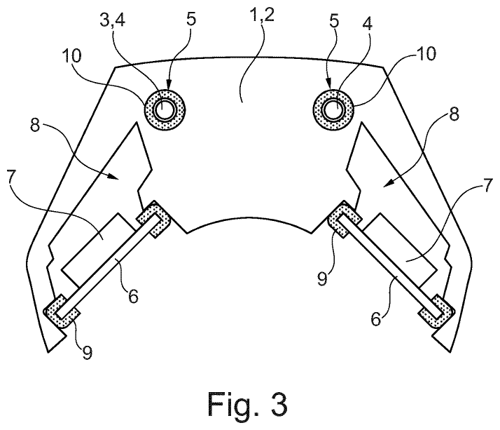

FIG. 2 is a schematic exploded perspective front view of the headrest shown in FIG. 1;

FIG. 3 is a schematic horizontal cross-section view of the headrest shown in FIG. 1.

In relation with these figures, a headrest for a motor vehicle seat is described below, as well as an assembly for generating acoustic waves in a motor vehicle passenger compartment which includes such a headrest.

In this description, the terms of positioning in space (lateral, transverse, top, rear, . . . ) are taken to refer to the headrest positioned in the vehicle in the situation of use.

The headrest comprises a bearing block 1 provided with a padding cushion 2 made of elastically compressible foam, said block being supported by a rigid frame 3 for mounting said headrest at the top of the backrest of a motor vehicle seat (not shown).

The mounting frame 3 may comprise at least one rod 4, in particular made of metallic material, which is fitted into a duct 5 formed in the bearing block 1.

In particular, the bearing block 1 can comprise a housing, in particular made of molded plastic material, for absorbing energy in the event of an occupant's head impact, which is surrounded by the padding cushion 2, the duct 5 being formed in said housing.

In the embodiment shown, the mounting frame 3 has an inverted U-shaped geometry, the branches of which form two rods 4, each of which fits into a respective duct 5 formed in the bearing block 1.

The cushion 2 can take the form of a block of molded skin foam, with the skin arranged on the outside, said foam having a hardness greater than 25 shore A, and in particular of the order of 30 shore A.

The foam of the bearing block 1 can also have a density of between 0.20 and 0.30, and in particular of the order of 0.25.

The headrest is equipped with a generator of acoustic waves in the environment of said headrest, the generator comprising at least one plate 6 on which an electrodynamic transducer 7 is provided.

The plate 6 is attached to the bearing block 1 and arranged to be excited vibrationally by the transducer 7, in order to generate the acoustic waves. The assembly for generating acoustic waves in the passenger compartment includes a system for controlling the transducer 7 to excite vibrationally the plate 6 on which it is provided.

In the embodiment shown, the headrest comprises two generators arranged laterally on either side of the bearing block 1, each comprising a transducer 7 associated with a respective plate 6 to excite it vibrationally, so as to generate acoustic waves on either side of the head of a seat occupant.

In addition, the control system is arranged to drive each of the two transducers 7, either jointly or independently.

The padding cushion 2 is provided with two cavities 8 arranged laterally on either side of the bearing block 1, and in each of which a plate 6 is attached by its periphery to said padding cushion.

The plates 6 each have a Young's modulus E greater than 10 MPa, in particular comprised between 100 MPa and 1 GPa, so as to have a sufficiently high stiffness to generate the acoustic waves without deformation when they are excited vibrationally by their transducer 7.

To prevent the transmission of vibrations generated by the plate 6, the headrest comprises a vibrational decoupling means arranged between said plate and the bearing block 1 and/or between said bearing block and the rigid frame 3.

In particular, the vibrational decoupling means comprises two seals 9 made of elastomer material, each of which is interposed between a respective plate 6 and the padding cushion 2, each surrounding the periphery of said plate.

In the embodiment shown, the headrest also comprises a vibrational decoupling means arranged between the bearing block 1 and the rigid frame 3, in order to avoid propagation of vibrations at the level of the mounting of said bearing block on said frame, and thus propagation of said vibrations from said frame to the backrest of the seat.

To do so, this second decoupling means comprises two sleeves 10 made of elastomer material, each fitted to a respective rod 4, so as to be interposed between said rod and its mounting duct 5 in the bearing block 1.

Each decoupling means 9, 10 comprises an elastomer material having a Young's modulus E of less than 20 kPa, so as to provide sufficient flexibility to decouple the vibratory plate 6 from the bearing block 1 (for the seals 9) or to decouple said bearing block from the frame 3 (for the sleeves 10). In particular, the high flexibility of the material enables particularly effective vibrational decoupling at low frequencies, notably below 150 Hz, or even 100 Hz and up to 60 Hz.

In addition, the flexibility of the elastomer material is adapted to enable the decoupling means 9, 10 to withstand the mechanical stresses required for the headrest in the event of the seat occupant's head impacting on it.

The elastomer material is preferably foam-based, in particular polyurethane (PU) foam or EPDM (ethylene propylene diene monomer) foam rubber.

In addition, the elastomer material of the decoupling means 9, 10 has an ETA loss factor which is greater than 0.2, so as to optimize its decoupling function.

Advantageously, the foam of the cushion 2 has a flexibility which is adapted to contribute to vibrational decoupling between the bearing block 1 and the plates 6, while at the same time having a sufficient rigidity to ensure the holding of said plates in their respective cavities 8. In particular, the foam of the cushion 2 has a Young's modulus E greater than 20 kPa, enabling vibrational decoupling at medium and high frequencies.

The bearing block 1 can also be coated with an appearance layer (not shown), notably for aesthetic reasons and to conceal and/or protect the acoustic wave generators.

1. A headrest for a motor vehicle seat, said headrest comprising a bearing block (1) provided with a padding cushion (2) made of elastically compressible foam, said block being supported by a rigid frame (3) for mounting said headrest at the top of the backrest of said seat, said headrest being equipped with a generator for generating acoustic waves in the environment of said headrest, said headrest being characterized in that the generator comprises at least one plate (6) on which an electrodynamic transducer (7) is provided, said plate being attached to the bearing block (1) and being arranged to be excited vibrationally by said transducer in order to generate the acoustic waves, said headrest comprising a vibrational decoupling means (9, 10) which is arranged between said plate and said bearing block and/or between said bearing block and the rigid frame (3), said decoupling means comprising an elastomer material having a Young's modulus E of less than 20 kPa.

2. Headrest according to claim 1, characterized in that the elastomer material of the decoupling means (9, 10) has an ETA loss factor which is greater than 0.2.

3. Headrest according to claim 1, characterized in that it comprises two generators arranged laterally on either side of the bearing block (1), so as to generate acoustic waves on each side of the head of a seat occupant.

4. Headrest according to claim 1, characterized in that the mounting frame (3) comprises at least one rod (4) which is fitted into a duct (5) formed in the bearing block (1), the vibrational decoupling means comprising a sleeve (10) made of elastomer material which is interposed between the rod (4) and the duct (5).

5. Headrest according to claim 4, characterized in that the mounting frame (3) comprises two rods (4) each fitted with a sleeve (10) made of elastomer material.

6. Headrest according to claim 1, characterized in that the plate (6) is attached to the padding cushion (2).

7. Headrest according to claim 6, characterized in that the vibrational decoupling means comprises a seal (9) made of elastomer material which is interposed between the plate (6) and the padding cushion (2).

8. Headrest according to claim 7, characterized in that the padding cushion (2) is provided with at least one cavity (8) in which the plate (6) is fixed by its periphery, the seal (9) surrounding said periphery.

9. Headrest according to claim 1, characterized in that the plate (6) has a Young's modulus E which is greater than 10 MPa.

10. An assembly for generating acoustic waves in a motor vehicle passenger compartment, said assembly comprising a headrest according to claim 1, and a system for controlling at least one transducer (7) to excite vibrationally the plate (6) on which it is provided.
